(19) United States
(12) Patent Application Publication
(10) Pub. No.: US 2022/0350802 A1
(43) Pub. Date: Nov. 3, 2022

(54) QUERY PERFORMANCE

(71) Applicant: International Business Machines Corporation, Armonk, NY (US)

(72) Inventors: Kapish Kumar, Bangalore (IN); Juilee A. Joshi, Pune (IN); Rohit Raut, Pune (IN)

(21) Appl. No.: 17/302,273

(22) Filed: Apr. 29, 2021

(51) Int. Cl. G06F 16/2453; G06N 20/00

(52) U.S. Cl. CPC G06F 16/24537; G06F 16/24532; G06F 16/24542; G06N 20/00

(57) ABSTRACT

An approach is provided for improving query performance. A query is received whose execution includes a first join of tables having sets of records and includes a second join with a next table whose set of records is smaller than a set of transient records resulting from the first join. A threshold for a number of records in the next table is received. A first count of the transient records resulting from the first join is estimated. A second count of a number of records in the next table is determined. It is determined that the second count is less than the threshold. Based on the second count being less than the threshold and without using the first count, a query execution plan is generated to include a broadcast of the records in the next table to data slices without including a broadcast of the transient records.

### BACKGROUND

The present invention relates to database queries, and more particularly to improving a performance of a database query.

In a massively parallel processing (mpp) environment, table data is stored in multiple data slices, nodes, or multiple logical nodes (mlns). Data is moved into multiple data slices based on a distribution key of a database table, which is defined during table creation. Based on the distribution key of the table, data is stored into different data slices. In response to a complex query, the mpp environment facilitates query execution by allowing the complex query to be executed in parallel. An optimizer decides how a query is to be executed based on several factors, including parameters such as statistics of the table, cardinality value, distribution key, etc. The optimizer decides how to proceed with query execution based on an estimation of the aforementioned parameters at an initial phase and in between the query execution.

### SUMMARY

In one embodiment, the present invention provides a computer-implemented method. The method includes receiving, by one or more processors, a query whose execution in a massively parallel processing (mpp) environment includes a first join of multiple tables having sets of records and further includes a subsequent second join with a next table whose set of records is smaller than a set of intermediate transient records resulting from the first join. The method further includes receiving, by the one or more processors, min_row_threshold, which is (i) a threshold value for a number of records in the next table and (ii) a parameter of an optimizer that determines a query execution plan for the query. The method further includes estimating, by the one or more processors and using the optimizer, a first count of the set of intermediate transient records resulting from the first join. The method further includes determining, by the one or more processors and using the optimizer, a second count of a number of records in the next table. The method further includes determining, by the one or more processors and using the optimizer, that the second count is less than min_row_threshold. The method further includes based on the second count being less than min_row_threshold and without using the estimated first count, generating, by the one or more processors and using the optimizer, the query execution plan to include a broadcast of the set of records in the next table to data slices in the mpp environment without including a broadcast of the intermediate transient records.

A computer program product and a computer system corresponding to the above-summarized method are also described and claimed herein.

### BRIEF DESCRIPTION OF THE DRAWINGS

FIG. 1 is a block diagram of a system for improving query performance, in accordance with embodiments of the present invention.

FIG. 2 is a flowchart of a process of improving query performance, where the process is implemented in the system of FIG. 1, in accordance with embodiments of the present invention.

FIG. 3 is an example of improving query performance using the process of FIG. 2 and the system of FIG. 1, in accordance with embodiments of the present invention.

FIG. 4 is a block diagram of a computer that is included in the system of FIG. 1 and that implements the process of FIG. 2, in accordance with embodiments of the present invention.

### DETAILED DESCRIPTION

### Overview

If the statistics of a database table are not up-to-date, an optimizer may produce an incorrect query execution plan and the query execution may be delayed. Similarly, during the query execution phase, if there is processing skew on transient tables, then the overall query execution may be delayed. In a case in which two or more substantially large tables (i.e., tables having relatively large numbers of records) are involved in a join operation and in which complex query conditions may be present, an optimizer can incorrectly estimate the cardinality value of transient records after the join. Transient records are also referred to herein as “intermediate transient records.” If the aforementioned join is being followed by a subsequent join with a small table (i.e., a table whose set of records is smaller than the set of intermediate transient records resulting from the join of the aforementioned two or more large tables), the incorrect cardinality value estimation is likely to cause an undesirable increase in the overall query execution time. If the cardinality value estimation of the intermediate transient records after the join of the first two or more tables is done incorrectly (i.e., a substantial underestimation of the actual cardinality value, which is a substantially large cardinality value), then the optimizer may decide to broadcast the result sets as part of the query execution. The optimizer makes the decision to broadcast the result sets because the decision is based on the incorrect estimation that the first join of the two or more tables results in a relatively low cardinality value. Broadcasting a substantially large dataset across each data slice is an expensive, time-consuming task. The decision to broadcast a relatively large dataset compared to a relatively small table involved in the subsequent join delays the overall query execution and diminishes query performance. Furthermore, due to the aforementioned issues, a query can keep running endlessly and consume a huge amount of resources for its execution, thereby negatively impacting the execution of other queries.

Embodiments of the present invention address the aforementioned unique challenges of query performance by providing the optimizer with a new optimizer parameter, herein referred to as min_row_threshold. The optimizer uses the min_row_threshold parameter to determine whether or not to broadcast intermediate transient records resulting from a join of multiple tables. By using the new optimizer parameter, the optimizer avoids broadcasting a large number of intermediate transient records due to an incorrect estimation of cardinality by the optimizer. The min_row_threshold parameter is a self-adjusting value whose adjustment is based on the query and the data available in the tables involved in the query. In one embodiment, the min_row_threshold parameter has a default value of 20,000 and a user has an option to change the value of the parameter per the user's requirements.

In one embodiment, as database queries are executed and the min_row_threshold parameter is used to decide whether to broadcast intermediate transient records, a self-learning machine learning system is also executing and checking section actuals (i.e., the actual cardinality value that was used to broadcast and also the cardinality value or statistics on the other side of the join). In one embodiment, the machine learning system also tracks the top frequently run SQL queries, checks against the actual cardinality, and stores the cardinality values. Over a period of time, after the machine learning system finds a pattern for the tracked queries, the machine learning system adjusts the min_row_threshold parameter per the query requirements. In one embodiment, the optimizer designates any table that contains a number of records that is less than the min_row_threshold as a broadcasting table, even if the optimizer underestimates the number of intermediate transient records resulting from an initial join of multiple tables. The condition for the aforementioned designation as a broadcasting table is that the table on the other side of the join is created after data processing of two or more tables being joined and/or complex query conditions.

### System for Improving Query Performance

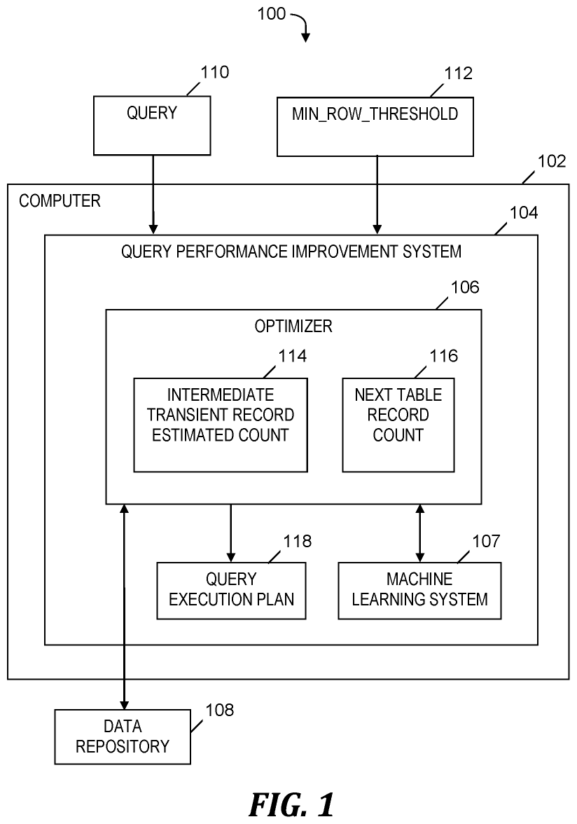

FIG. 1 is a block diagram of a system 100 for improving query performance, in accordance with embodiments of the present invention. System 100 includes a computer 102 that includes a software-based query performance improvement system 104 which includes an optimizer 106 and a machine learning system 107 (i.e., a self-learning machine learning system). Optimizer 106 accesses tables in a database and information about the tables in the database, where the database and information about the tables is stored in a data repository 108.

Query performance improvement system 104 receives a query that includes a first join of multiple tables (not shown) and further includes a subsequent second join with a smaller next table (not shown) (i.e., a table whose number of records is less than the number of intermediate transient records (i.e., actual intermediate transient records) resulting from the first join, which is prior to the second join). Query performance improvement system 104 also receives a new optimizer parameter: min_row_threshold 112, which indicates a threshold number of records in the aforementioned next table.

Optimizer 106 calculates intermediate transient record estimated count 114 (i.e., an estimate of a count of the number of intermediate transient records resulting from the aforementioned first join). Optimizer 106 also calculates a next table record count 116 (i.e., a count of the number of records in the aforementioned next table).

Optimizer 106 generates a query execution plan 118. If the next table record count 116 is less than min_row_threshold 112, query execution plan 118 includes a broadcast of records in the next table to data slices in an mpp environment, regardless of the intermediate transient record estimated count 114 and without including a broadcast of the intermediate transient records.

Machine learning system 107 tracks section actuals, determines patterns in estimated and actual cardinalities, and adjusts the value of min_row_threshold 112 based on the patterns.

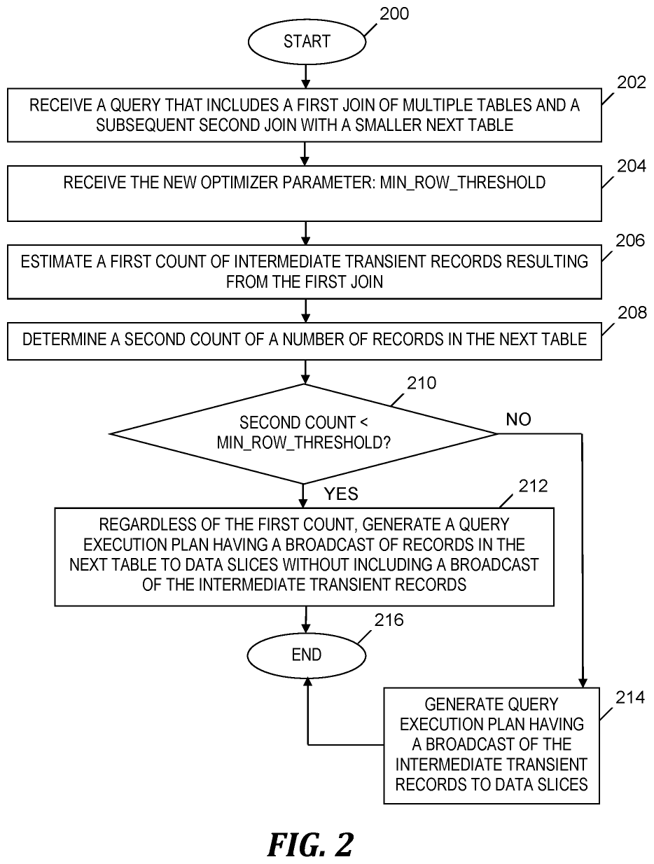

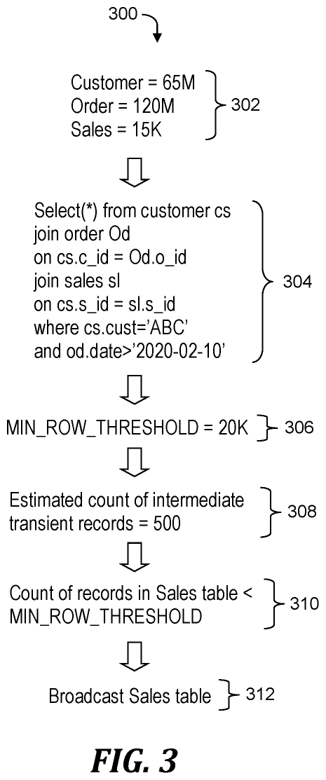

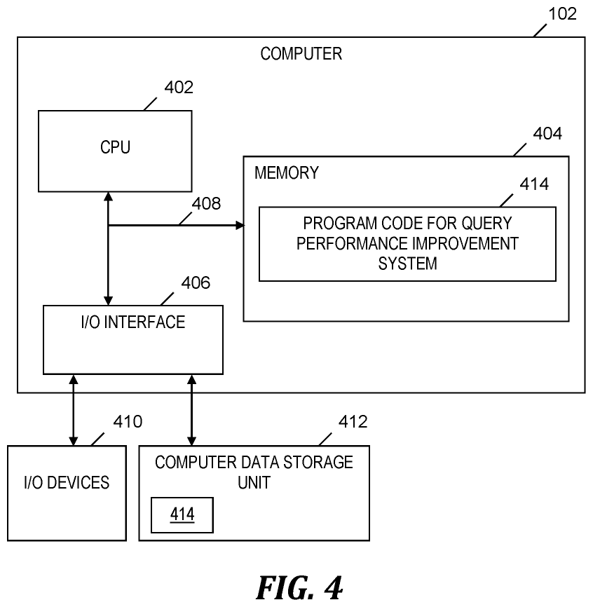

The functionality of the components shown in FIG. 1 is described in more detail in the discussion of FIG. 2, FIG. 3, and FIG. 4 presented below.

### Process for Improving Query Performance

FIG. 2 is a flowchart of a process of improving query performance, where the process is implemented in the system of FIG. 1, in accordance with embodiments of the present invention. The process of FIG. 2 begins at a start node 200. In step 202, query performance improvement system 104 (see FIG. 1) receives query 110 (see FIG. 1) whose execution includes a first join of multiple tables and a subsequent second join with a next table. The number of records in the next table is smaller than the number of intermediate transient records (i.e., actual intermediate transient records) resulting from the first join.

In step 204, query performance improvement system 104 (see FIG. 1) receives the new optimizer parameter, min_row_threshold 112 (see FIG. 1). In one embodiment, min_row_threshold 112 (see FIG. 1) has a default value of 20K (i.e., 20,000). As used herein, the abbreviation “K” means “thousand.”

In step 206, query performance improvement system 104 (see FIG. 1) calculates intermediate transient record estimated count 114 (see FIG. 1) (i.e., estimates a first count of intermediate transient records resulting from the first join of the multiple tables).

In step 208, query performance improvement system 104 (see FIG. 1) determines next table record count 116 (see FIG. 1) (i.e., determines a second count of a number of records in the next table involved in the second join).

In step 210, query performance improvement system 104 (see FIG. 1) determines whether the next table record count 116 (see FIG. 1) is less than min_row_threshold 112 (see FIG. 1). If query performance improvement system 104 (see FIG. 1) determines in step 210 that next table record count 116 (see FIG. 1) is less than min_row_threshold 112 (see FIG. 1), then the Yes branch of step 210 is followed and step 212 is performed.

In step 212, query performance improvement system 104 (see FIG. 1) generates query execution plan 118 (see FIG. 1) so that the query execution plan includes a broadcast of records in the next table to data slices in the mpp environment without including a broadcast of the intermediate transient records resulting from the first join of the multiple tables. The generation of query execution plan 118 (see FIG. 1) in step 212 is performed regardless of the value of the intermediate transient record estimated count 114 (see FIG. 1) and regardless of whether intermediate transient estimated count 114 (see FIG. 1) is larger or smaller than next table record count 116 (see FIG. 1).

In one embodiment and in response to step 212, a query execution component (not shown in FIG. 1) executes query 110 (see FIG. 1) according to query execution plan 118 (see FIG. 1), where the execution of query 110 (see FIG. 1) includes broadcasting the records in the next table to the data slices in the mpp environment subsequent to performing the second join with the next table.

Returning to step 212, if query performance improvement system 104 (see FIG. 1) determines that next table record count 116 (see FIG. 1) is not less than min_row_threshold 112 (see FIG. 1), then the No branch of step 210 is followed and step 214 is performed.

In step 214, query performance improvement system 104 (see FIG. 1) generates query execution plan 118 (see FIG. 1) so that the query execution plan includes a broadcast of the intermediate transient records to data slices in the mpp environment.

After step 212 following the Yes branch of step 210 and after step 214 following the No branch of step 210, the process of FIG. 2 ends at an end node 216.

In one embodiment, over time and for multiple queries executed in the mpp environment, machine learning system 107 (see FIG. 1) performs the following:

(1) tracks (i) estimated cardinalities of records resulting from joins in the multiple queries and (ii) actual cardinalities of the records resulting from the joins in the multiple queries;

(2) based on the tracked estimated and actual cardinalities, adjusts the value of min_row_threshold 112 (see FIG. 1); and

(3) identifies a pattern in the tracked estimated and actual cardinalities, where the adjustment of the value of the min_row_threshold 112 (see FIG. 1) is further based on the identified pattern.

In one embodiment, the process of FIG. 2 is enhanced to include query performance improvement system 104 (see FIG. 1) performing the following actions:

(1) receives a second query whose execution in the mpp environment includes (i) complex conditions that include multiple conditions within a where clause in a select statement and (ii) a third join with a second table, where the third join is performed subsequent to an execution of the complex conditions;

(2) using optimizer 106 (see FIG. 1), estimates a third count of second intermediate transient records resulting from an execution of the complex conditions;

(3) using optimizer 106 (see FIG. 1), determines a fourth count of a number of records in the second table;

(4) using optimizer 106 (see FIG. 1), determines that the fourth count is less than min_row_threshold 112 (see FIG. 1); and

(5) based on the fourth count being less than min_row_threshold 112 (see FIG. 1), without using the estimated third count, and by using optimizer 106 (see FIG. 1), generates a second query execution plan which includes a broadcast of the records in the second table to second data slices in the mpp environment without including a broadcast of the second intermediate transient records.

### Examples

FIG. 3 is an example 300 of improving query performance using the process of FIG. 2 and the system of FIG. 1, in accordance with embodiments of the present invention. Example 300 includes query performance improvement system 104 (see FIG. 1) having access to three database tables 302 (i.e., Customer, Order, and Sales tables) and their respective numbers of records (i.e., 65M records in the Customer table, 120M records in the Order table, and 15K records in the Sales table). As used herein, the abbreviation “M” means million.

The three database tables 302 are involved in a query 304. In step 202 (see FIG. 2), query performance improvement system 104 (see FIG. 1) receives query 304, which includes a first join of the Customer and Order tables and a second join with the Sales table. In example 300, an execution of the first join of the Customer and Order tables results in 60M records after evaluating other conditions. The 60M records is the actual count of the number of intermediate transient records resulting from the first join. Subsequently, the intermediate transient records are to be joined to the Sales table.

In step 204 (see FIG. 2), query performance improvement system 104 (see FIG. 1) receives min_row_threshold 112 (see FIG. 1), whose value 306 in example 300 is 20K.

In step 206 (see FIG. 2), instead of estimating a count relatively close to the actual count of 60M records, optimizer 106 (see FIG. 1) makes an estimation 308 (i.e., a deficient estimation) by estimating the intermediate transient records to be 500 records (i.e., determines the intermediate transient record estimated count 114 (see FIG. 1) to be 500 records).

In step 208 (see FIG. 2) and before the second join, optimizer 106 (see FIG. 1) checks the table involved in the second join (i.e., the Sales table) and determines a count (i.e., 15K) of the number of records in the Sales table (i.e., determines that the next table record count 116 (see FIG. 1) is 15K records). In step 210 (see FIG. 2), optimizer 106 (see FIG. 1) makes a determination 310 that the count of the number of records in the Sales table is less than the value of min_row_threshold 112 (see FIG. 1) (i.e., determines that the 15K records in the Sales table is less than 20K, which is value 306). In response to making the determination 310 and regardless of the 500 record estimation for the count of the intermediate transient records, optimizer 106 (see FIG. 1) saves the intermediate transient records in a temporary table and later makes a broadcast 312 of the Sales table. In example 300, optimizer 106 (see FIG. 1) ensures the broadcast 312 of the smaller table (i.e., the Sales table whose 15K records is smaller than 60M, the actual count of the intermediate transient records resulting from the first join), even with a deficient estimation of the count of the intermediate transient records after the processing of the Customer and Order tables in the first join. By ensuring the broadcast 312 as described above, optimizer 106 (see FIG. 1) generates query execution plan 118 (see FIG. 1), which provides an improvement in query execution time compared to query execution plans generated by known approaches. That is, broadcasting the smaller table (i.e., Sales table) provides a faster query execution time than broadcasting the substantially large number of intermediate transient records (i.e., 60M records).

In contrast to the query performance improvement system 104 (see FIG. 1) using the broadcast 312, which provides the improvement in query execution time, a known approach decides to broadcast the large number of intermediate transient records (i.e., 60M records) because its decision is based on the deficient estimation of only 500 intermediate transient records after the first join, where the estimated count of 500 records is substantially less than the number of records in the Sales table (i.e., 15K records). Using the known approach, the optimizer broadcasts the 60M intermediate transient records across all data slices in an mpp environment, which is time-consuming and causes a significant delay in query execution and may negatively impact the execution of other queries.

### Computer System

FIG. 4 is a block diagram of a computer that is included in the system of FIG. 1 and that implements the process of FIG. 2, in accordance with embodiments of the present invention. Computer 102 is a computer system that generally includes a central processing unit (CPU) 402, a memory 404, an input/output (I/O) interface 406, and a bus 408. Further, computer 102 is coupled to I/O devices 410 and a computer data storage unit 412. CPU 402 performs computation and control functions of computer 102, including executing instructions included in program code 414 for query performance improvement system 104 (see FIG. 1) to perform a method of improving a performance of a query, where the instructions are executed by CPU 402 via memory 404. CPU 402 may include a single processing unit or processor or be distributed across one or more processing units or one or more processors in one or more locations (e.g., on a client and server).

Memory 404 includes a known computer readable storage medium, which is described below. In one embodiment, cache memory elements of memory 404 provide temporary storage of at least some program code (e.g., program code 414) in order to reduce the number of times code must be retrieved from bulk storage while instructions of the program code are executed. Moreover, similar to CPU 402, memory 404 may reside at a single physical location, including one or more types of data storage, or be distributed across a plurality of physical systems or a plurality of computer readable storage media in various forms. Further, memory 404 can include data distributed across, for example, a local area network (LAN) or a wide area network (WAN).

I/O interface 406 includes any system for exchanging information to or from an external source. I/O devices 410 include any known type of external device, including a display, keyboard, etc. Bus 408 provides a communication link between each of the components in computer 102, and may include any type of transmission link, including electrical, optical, wireless, etc.

I/O interface 406 also allows computer 102 to store information (e.g., data or program instructions such as program code 414) on and retrieve the information from computer data storage unit 412 or another computer data storage unit (not shown). Computer data storage unit 412 includes one or more known computer readable storage media, where a computer readable storage medium is described below. In one embodiment, computer data storage unit 412 is a non-volatile data storage device, such as, for example, a solid-state drive (SSD), a network-attached storage (NAS) array, a storage area network (SAN) array, a magnetic disk drive (i.e., hard disk drive), or an optical disc drive (e.g., a CD-ROM drive which receives a CD-ROM disk or a DVD drive which receives a DVD disc).

Memory 404 and/or storage unit 412 may store computer program code 414 that includes instructions that are executed by CPU 402 via memory 404 to improve a performance of a query. Although FIG. 4 depicts memory 404 as including program code, the present invention contemplates embodiments in which memory 404 does not include all of code 414 simultaneously, but instead at one time includes only a portion of code 414.

Further, memory 404 may include an operating system (not shown) and may include other systems not shown in FIG. 4. Data repository 108 (see FIG. 1) may be included in computer data storage unit 412.

As will be appreciated by one skilled in the art, in a first embodiment, the present invention may be a method; in a second embodiment, the present invention may be a system; and in a third embodiment, the present invention may be a computer program product.

Any of the components of an embodiment of the present invention can be deployed, managed, serviced, etc. by a service provider that offers to deploy or integrate computing infrastructure with respect to improving a performance of a query. Thus, an embodiment of the present invention discloses a process for supporting computer infrastructure, where the process includes providing at least one support service for at least one of integrating, hosting, maintaining and deploying computer-readable code (e.g., program code 414) in a computer system (e.g., computer 102) including one or more processors (e.g., CPU 402), wherein the processor(s) carry out instructions contained in the code causing the computer system to improve a performance of a query. Another embodiment discloses a process for supporting computer infrastructure, where the process includes integrating computer-readable program code into a computer system including a processor. The step of integrating includes storing the program code in a computer-readable storage device of the computer system through use of the processor. The program code, upon being executed by the processor, implements a method of improving a performance of a query.

While it is understood that program code 414 for improving a performance of a query may be deployed by manually loading directly in client, server and proxy computers (not shown) via loading a computer-readable storage medium (e.g., computer data storage unit 412), program code 414 may also be automatically or semi-automatically deployed into computer 102 by sending program code 414 to a central server or a group of central servers. Program code 414 is then downloaded into client computers (e.g., computer 102) that will execute program code 414. Alternatively, program code 414 is sent directly to the client computer via e-mail. Program code 414 is then either detached to a directory on the client computer or loaded into a directory on the client computer by a button on the e-mail that executes a program that detaches program code 414 into a directory. Another alternative is to send program code 414 directly to a directory on the client computer hard drive. In a case in which there are proxy servers, the process selects the proxy server code, determines on which computers to place the proxy servers' code, transmits the proxy server code, and then installs the proxy server code on the proxy computer. Program code 414 is transmitted to the proxy server and then it is stored on the proxy server.

Another embodiment of the invention provides a method that performs the process steps on a subscription, advertising and/or fee basis. That is, a service provider can offer to create, maintain, support, etc. a process of improving a performance of a query. In this case, the service provider can create, maintain, support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The present invention may be a system, a method, and/or a computer program product at any possible technical detail level of integration. The computer program product may include a computer readable storage medium (or media) (i.e., memory 404 and computer data storage unit 412) having computer readable program instructions 414 thereon for causing a processor (e.g., CPU 402) to carry out aspects of the present invention.

The computer readable storage medium can be a tangible device that can retain and store instructions (e.g., program code 414) for use by an instruction execution device (e.g., computer 102). The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions (e.g., program code 414) described herein can be downloaded to respective computing/processing devices (e.g., computer 102) from a computer readable storage medium or to an external computer or external storage device (e.g., computer data storage unit 412) via a network (not shown), for example, the Internet, a local area network, a wide area network and/or a wireless network. The network may comprise copper transmission cables, optical transmission fibers, wireless transmission, routers, firewalls, switches, gateway computers and/or edge servers. A network adapter card (not shown) or network interface (not shown) in each computing/processing device receives computer readable program instructions from the network and forwards the computer readable program instructions for storage in a computer readable storage medium within the respective computing/processing device.

Computer readable program instructions (e.g., program code 414) for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations (e.g., FIG. 2) and/or block diagrams (e.g., FIG. 1 and FIG. 4) of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions (e.g., program code 414).

These computer readable program instructions may be provided to a processor (e.g., CPU 402) of a general purpose computer, special purpose computer, or other programmable data processing apparatus (e.g., computer 102) to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium (e.g., computer data storage unit 412) that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions (e.g., program code 414) may also be loaded onto a computer (e.g. computer 102), other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A computer-implemented method comprising:
receiving, by one or more processors, a query whose execution in a massively parallel processing (mpp) environment includes a first join of multiple tables having sets of records and further includes a subsequent second join with a next table whose set of records is smaller than a set of intermediate transient records resulting from the first join;
receiving, by the one or more processors, min_row_threshold, which is (i) a threshold value for a number of records in the next table and (ii) a parameter of an optimizer that determines a query execution plan for the query;
estimating, by the one or more processors and using the optimizer, a first count of the set of intermediate transient records resulting from the first join;
determining, by the one or more processors and using the optimizer, a second count of a number of records in the next table;
determining, by the one or more processors and using the optimizer, that the second count is less than min_row_threshold; and
based on the second count being less than min_row_threshold and without using the estimated first count, generating, by the one or more processors and using the optimizer, the query execution plan to include a broadcast of the records in the next table to data slices in the mpp environment without including a broadcast of the set of intermediate transient records.

2. The method of claim 1, further comprising:
for multiple queries executed in the mpp environment, tracking, by the one or more processors, (i) estimated cardinalities of records resulting from joins in the multiple queries and (ii) actual cardinalities of the records resulting from the joins in the multiple queries; and
based on the tracked estimated and actual cardinalities, adjusting, by the one or more processors, the min_row_threshold.

3. The method of claim 2, further comprising:
identifying, by the one or more processors and using a machine learning system, a pattern in the tracked estimated and actual cardinalities, wherein the adjusting the min_row_threshold is further based on the identified pattern.

4. The method of claim 1, further comprising:
determining, by the one or more processors, that the estimated first count of the set of intermediate transient records resulting from the first join is less than the second count of the number of records in the next table, wherein the generating the query execution plan to include the broadcast of the records in the next table is performed even though the estimated first count is less than the second count.

5. The method of claim 1, further comprising:
executing, by the one or more processors and using the query execution plan, the query within a first query execution time, wherein the first query execution time is less than a second query execution time provided by a second query execution plan that includes the broadcast of the set of intermediate transient records instead of the broadcast of the records in the next table.

6. The method of claim 1, further comprising:
receiving, by the one or more processors, a second query whose execution in the mpp environment includes (i) complex conditions that include multiple conditions within a where clause in a select statement and (ii) a third join with a second table, the third join being subsequent to an execution of the complex conditions;
estimating, by the one or more processors and using the optimizer, a third count of second intermediate transient records resulting from an execution of the complex conditions;
determining, by the one or more processors and using the optimizer, a fourth count of a number of records in the second table;
determining, by the one or more processors and using the optimizer, that the fourth count is less than min_row_threshold; and
based on the fourth count being less than min_row_threshold and without using the estimated third count, generating, by the one or more processors and using the optimizer, a second query execution plan to include a broadcast of the records in the second table to second data slices in the mpp environment without including a broadcast of the second intermediate transient records.

7. The method of claim 1, further comprising:
executing, by the one or more processors, the query, wherein the executing includes broadcasting the records in the next table to the data slices subsequent to performing the second join with the next table.

8. The method of claim 1, further comprising:
providing at least one support service for at least one of creating, integrating, hosting, maintaining, and deploying computer readable program code in the computer, the program code being executed by a processor of the computer to implement the receiving the query, the receiving the min_row_threshold, the estimating the first count, the determining the second count, the determining that the second count is less than min_row_threshold, and the generating the query execution plan to include the broadcast of the records in the next table.

9. A computer program product for improving query performance, the computer program product comprising:
one or more computer readable storage media having computer readable program code collectively stored on the one or more computer readable storage media, the computer readable program code being executed by a central processing unit (CPU) of a computer system to cause the computer system to perform a method comprising:
the computer system receiving a query whose execution in a massively parallel processing (mpp) environment includes a first join of multiple tables having sets of records and further includes a subsequent second join with a next table whose set of records is smaller than a set of intermediate transient records resulting from the first join;
the computer system receiving min_row_threshold, which is (i) a threshold value for a number of records in the next table and (ii) a parameter of an optimizer that determines a query execution plan for the query;
the computer system estimating, by using the optimizer, a first count of the set of intermediate transient records resulting from the first join;
the computer system determining, by using the optimizer, a second count of a number of records in the next table;
the computer system determining, by using the optimizer, that the second count is less than min_row_threshold; and
based on the second count being less than min_row_threshold and without using the estimated first count, the computer system generating, by using the optimizer, the query execution plan to include a broadcast of the records in the next table to data slices in the mpp environment without including a broadcast of the set of intermediate transient records.

10. The computer program product of claim 9, wherein the method further comprises:
for multiple queries executed in the mpp environment, the computer system tracking (i) estimated cardinalities of records resulting from joins in the multiple queries and (ii) actual cardinalities of the records resulting from the joins in the multiple queries; and
based on the tracked estimated and actual cardinalities, the computer system adjusting the min_row_threshold.

11. The computer program product of claim 10, wherein the method further comprises:
the computer system identifying, by using a machine learning system, a pattern in the tracked estimated and actual cardinalities, wherein the adjusting the min_row_threshold is further based on the identified pattern.

12. The computer program product of claim 9, wherein the method further comprises:
the computer system determining that the estimated first count of the set of intermediate transient records resulting from the first join is less than the second count of the number of records in the next table, wherein the generating the query execution plan to include the broadcast of the records in the next table is performed even though the estimated first count is less than the second count.

13. The computer program product of claim 9, wherein the method further comprises:
the computer system executing, by using the query execution plan, the query within a first query execution time, wherein the first query execution time is less than a second query execution time provided by a second query execution plan that includes the broadcast of the set of intermediate transient records instead of the broadcast of the records in the next table.

14. The computer program product of claim 9, wherein the method further comprises:
the computer system receiving a second query whose execution in the mpp environment includes (i) complex conditions that include multiple conditions within a where clause in a select statement and (ii) a third join with a second table, the third join being subsequent to an execution of the complex conditions;
the computer system estimating, by using the optimizer, a third count of second intermediate transient records resulting from an execution of the complex conditions;
the computer system determining, by using the optimizer, a fourth count of a number of records in the second table;
the computer system determining, by using the optimizer, that the fourth count is less than min_row_threshold; and
based on the fourth count being less than min_row_threshold and without using the estimated third count, the computer system generating, by using the optimizer, a second query execution plan to include a broadcast of the records in the second table to second data slices in the mpp environment without including a broadcast of the second intermediate transient records.

15. A computer system comprising:
a central processing unit (CPU);
a memory coupled to the CPU; and
one or more computer readable storage media coupled to the CPU, the one or more computer readable storage media collectively containing instructions that are executed by the CPU via the memory to implement a method of improving query performance, the method comprising:
the computer system receiving a query whose execution in a massively parallel processing (mpp) environment includes a first join of multiple tables having sets of records and further includes a subsequent second join with a next table whose set of records is smaller than a set of intermediate transient records resulting from the first join;
the computer system receiving min_row_threshold, which is (i) a threshold value for a number of records in the next table and (ii) a parameter of an optimizer that determines a query execution plan for the query;
the computer system estimating, by using the optimizer, a first count of the set of intermediate transient records resulting from the first join;
the computer system determining, by using the optimizer, a second count of a number of records in the next table;
the computer system determining, by using the optimizer, that the second count is less than min_row_threshold; and
based on the second count being less than min_row_threshold and without using the estimated first count, the computer system generating, by using the optimizer, the query execution plan to include a broadcast of the records in the next table to data slices in the mpp environment without including a broadcast of the set of intermediate transient records.

16. The computer system of claim 15, wherein the method further comprises:
for multiple queries executed in the mpp environment, the computer system tracking (i) estimated cardinalities of records resulting from joins in the multiple queries and (ii) actual cardinalities of the records resulting from the joins in the multiple queries; and
based on the tracked estimated and actual cardinalities, the computer system adjusting the min_row_threshold.

17. The computer system of claim 16, wherein the method further comprises:
the computer system identifying, by using a machine learning system, a pattern in the tracked estimated and actual cardinalities, wherein the adjusting the min_row_threshold is further based on the identified pattern.

18. The computer system of claim 15, wherein the method further comprises:
the computer system determining that the estimated first count of the set of intermediate transient records resulting from the first join is less than the second count of the number of records in the next table, wherein the generating the query execution plan to include the broadcast of the records in the next table is performed even though the estimated first count is less than the second count.

19. The computer system of claim 15, wherein the method further comprises:
the computer system executing, by using the query execution plan, the query within a first query execution time, wherein the first query execution time is less than a second query execution time provided by a second query execution plan that includes the broadcast of the set of intermediate transient records instead of the broadcast of the records in the next table.

20. The computer system of claim 15, wherein the method further comprises:
the computer system receiving a second query whose execution in the mpp environment includes (i) complex conditions that include multiple conditions within a where clause in a select statement and (ii) a third join with a second table, the third join being subsequent to an execution of the complex conditions;
the computer system estimating, by using the optimizer, a third count of second intermediate transient records resulting from an execution of the complex conditions;
the computer system determining, by using the optimizer, a fourth count of a number of records in the second table;
the computer system determining, by using the optimizer, that the fourth count is less than min_row_threshold; and
based on the fourth count being less than min_row_threshold and without using the estimated third count, the computer system generating, by using the optimizer, a second query execution plan to include a broadcast of the records in the second table to second data slices in the mpp environment without including a broadcast of the second intermediate transient records.
